(19) United States
(12) Patent Application Publication
(10) Pub. No.: US 2002/0147710 A1
(43) Pub. Date: Oct. 10, 2002

(54) System and method of recording and extracting relations between people and organizations

(75) Inventor: Rei-Row Hu, Taipei (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Galaxy Software Services

(21) Appl. No.: 10/057,290

(22) Filed: Jan. 24, 2002

(30) Foreign Application Priority Data
Apr. 10, 2001 (JP) 90108586

(51) Int. Cl. G06F 7/00

(52) U.S. Cl. 707/3

(57) ABSTRACT

A method and system for extracting both explicit and implicit social relations among people and organizations are provided. Various relations are explicitly defined in a tree structure in a social-relationship database. Based on the explicitly defined relations, implicit relations among people and organizations can also be extracted. According to a method for performing a database search concerning social relations of an entity (person or organization), first, in response to a search request received from a search requester, which contains the identity of the entity, explicit relations of the entity are extracted from the database. Next, implicit relations of the entity are extracted based on the extracted explicit relations. Thereafter, the extracted explicit and implicit relations may be formatted and sent to the search requester. In one embodiment, the method is implemented over a network, such as the Internet.

### CROSS-REFERENCE TO RELATED APPLICATION

This application is based upon and claims the benefit of priority from the prior Taiwanese Patent Application No. 90108586, filed on Apr. 10, 2001, the entire contents of which are incorporated herein by reference.

1. Field of the Invention

The present invention relates generally to databases, and more particularly to recording and extracting social relations among people and organizations.

2. Background of the Invention

A society blossoms as more people and organizations participate and interact with each other through various social activities. Each social activity creates a particular social relation among people and organizations. For example, people may be related to one another through work, through participation in civic or volunteer organizations, religious affiliations, through education (e.g., alumni relationships), or simply through blood relationship or by being friends. Organizations, such as companies, non-profit organizations, churches, etc., may also be related to one another through a conglomerate arrangement, by trade, by denomination, etc. These various relations among people and organizations can be explicitly defined in the form of a relational database, as well known in the art, and these explicit relations can be readily extracted. For example, one can extract the names of all people who work for the same company, or the names of all people who are related by blood, as long as these relations are explicitly defined in a database. On the other hand, “implicit” (or “indirect”) relations in a conventional database cannot be extracted.

### SUMMARY OF THE INVENTION

In accordance with the present invention, a method, apparatus, and computer-readable medium for extracting both explicit and implicit social relations among people and organizations from a database are provided.

In accordance with one aspect of the present invention, various relations among people and organizations are explicitly defined in a tree structure in a social-relationship database. Based on these explicitly defined relations, implicit relations among people and organizations can be extracted.

In accordance with a further aspect of the present invention, a method of searching social relations of a particular entity (person or organization) in a database is provided. The method includes generally two steps. First, in response to a search request for social relations of a particular entity, which is received from a search requester, explicit relations of the entity are extracted from the database. Second, implicit relations of the entity are extracted from the database based on the extracted explicit relations. The relations search may be conducted based on a desired search level as specified by the search requester. The extracted explicit and implicit relations may then be formatted and sent to the search requester for review. In one embodiment, the method is implemented over a network, such as the Internet.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a diagram depicting an overall computer system suitable for performing a method of the present invention;

FIG. 2A is a block diagram of the several components of a server illustrated in FIG. 1;

FIG. 2B is a block diagram of the several components of a client illustrated in FIG. 1;

FIG. 3 illustrates sample relations among people and organizations, which are explicitly defined in a tree structure in a social-relationship database of the present invention;

FIG. 4 is a flow diagram illustrating the logic used to define a social-relationship database;

FIGS. 5A-5D illustrate both explicit and implicit relations, which are extracted from the social-relationship database as shown in FIG. 3 at search levels 1 through 4, respectively;

FIG. 6 is a flow diagram illustrating the logic used to process a search request for relations between two entities;

FIG. 7 is a sample screen shot, which may be used to receive a search request for relations between two entities; and

FIG. 8 illustrates a sample screen shot, which may be returned in response to the search request of FIG. 7, displaying both explicit and implicit relations between the two entities.

### DETAILED DESCRIPTION OF THE PREFERRED EMBODIMENT

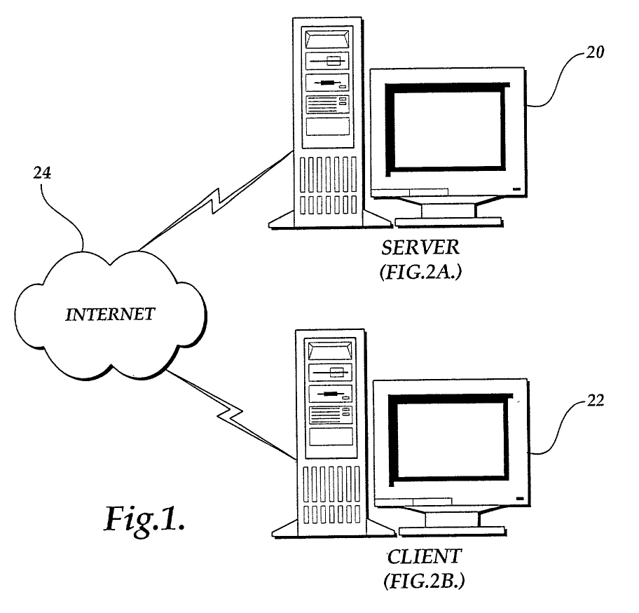

FIG. 1 depicts a client/server environment in which the present invention of extracting both explicit and implicit relations among people and organizations can be implemented. In accordance with the present invention, a server 20 receives a search request from a client 22 via the Internet 24. The server 20 performs the requested search, formats the results, and returns them to the search requester, i.e., the client 22. The client 22 then displays the results. In the illustrated embodiment, the client is connected to the server via the Internet. However, it will be appreciated that the client 22 may be connected to the server 20 by other means, such as via an intra-network or remotely via a modem. The client 22 and server 20 can also be the same computer. Thus, the search request and search can be performed on a stand-alone computer, as well as in a networked environment.

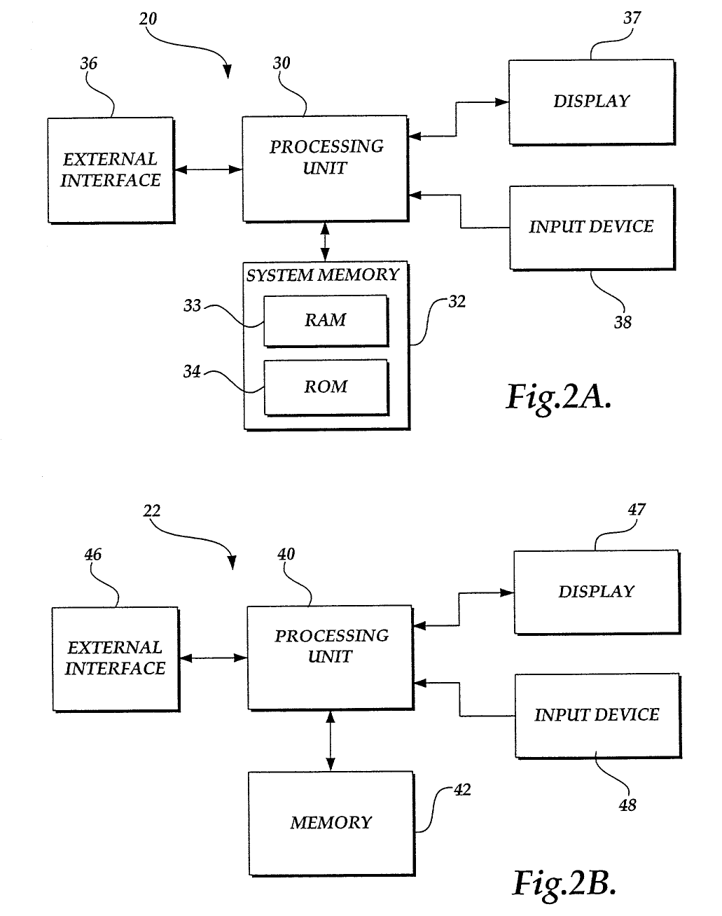

FIG. 2A depicts several of the key components of the server 20 used to implement the present invention. Those of ordinary skill in the art will appreciate that the server 20 includes many more components than those shown in FIG. 2A. However, it is not necessary that all of these generally conventional components be shown in order to disclose an illustrative embodiment for practicing the present invention. As shown in FIG. 2A, the server 20 includes a processing unit 30, a display 37, and a system memory 32. The system memory 32 generally comprises a random access memory (RAM) 33, read-only memory (ROM) 34, and a permanent mass storage device, such as a hard disk drive, tape drive, optical drive, floppy disk drive, or a combination thereof. The system memory 32 stores the program code and data necessary for performing a method of the present invention, in particular, the memory 32 stores a social-relationship database, which will be more fully explained later. Alternatively, at least some of the memory 32 may be coupled to a network, to which the server 20 is connected and through which the server 20 can access the memory 32, as opposed to physically residing in the server 20 itself.

The server 20 also includes an input device 38 and an external interface 36. The input device 38 may be implemented by a user of the server 20 to input data, for example, to define explicit social relations among people and organizations to construct the social-relationship database. The input device may be of any conventional type, such as a keyboard, mouse, track-ball, etc., or a combination thereof. The server 20 communicates to the client 22 through the external interface 36. In one actual embodiment of the present invention, the server is connected to a local area network, which in turn is connected to the Internet. Thus, the external interface 36 comprises a network interface card including the necessary circuitry for such a connection. The external interface 36 is also constructed for use with the Transmission Control Protocol/Internet Protocol (i.e., the standard transmission protocol for the Internet, also known as “TCP/IP”), the particular network configuration of the local area network it is connecting to, and a particular type of coupling medium. In other embodiments of the present invention, the external interface 36 comprises a modem.

As noted above, the client 22 sends the search request to the server 20, and the server 20 returns the search results to the client via a remote connection established by the external interface 36. The key components of the client 22 used to initiate a search request and display the search results are shown in FIG. 2B. Again, those of ordinary skill in the art will appreciate that the client 22 includes many more components than those shown in FIG. 2B. However, it is not necessary that all of these generally conventional components be shown in order to disclose an illustrative embodiment for practicing the present invention. The client 22 communicates with the server 20 over a remote connection via an external interface 46. In the actual embodiment of the present invention described herein, the client 22 is connected to a local area network, which in turn is connected to the Internet. Accordingly, external interface 46 includes the necessary circuitry for such a connection, and is also constructed for use with the TCP/IP protocol, the particular network configuration of a local area network it is connecting to, and a particular type of communication medium. In another embodiment of the present invention, the client's external interface 46 is a modem through which the client 22 may contact the server 20 directly.

In addition to the external interface 46, the client computer includes a display 47, a memory 42, and a processing unit 40. The memory 42 stores the search results provided by the server 20 and the program code implemented by the processing unit 40 for presenting the search results on the display 47, for example, using a Web browser.

Finally, the client 22 includes an input device 48, which may be implemented by a user to input the search request. The input device 48 may be of any conventional type, such as a keyboard, mouse, track-ball, etc., or some combination thereof.

A preferred embodiment of the invention is implemented using the Internet. However, it will be appreciated that other embodiments, such as a stand-alone computer, are possible. In the Internet embodiment shown and described herein, a user (i.e., client 22 in FIG. 1) initiates a search by entering a search request in data entry fields displayed on a Web page. The search request is included as part of a Uniform Resource Locator (URL) that requests information from a World Wide Web server (e.g., server 20 in FIG. 1). The World Wide Web server parses the URL to obtain the search request, extracts both explicit and implicit relations from the social-relationship database in response to the search request, and returns the search results to the search requester. It will be appreciated that the search requester need not be a user in the conventional sense (i.e., person), but may be, for example, a computer software application that automatically generates a search request.

In order to extract both explicit and implicit relations among people and organizations in response to a search request, a social-relationship database must exist that records both explicit and implicit relations in an extractable form.

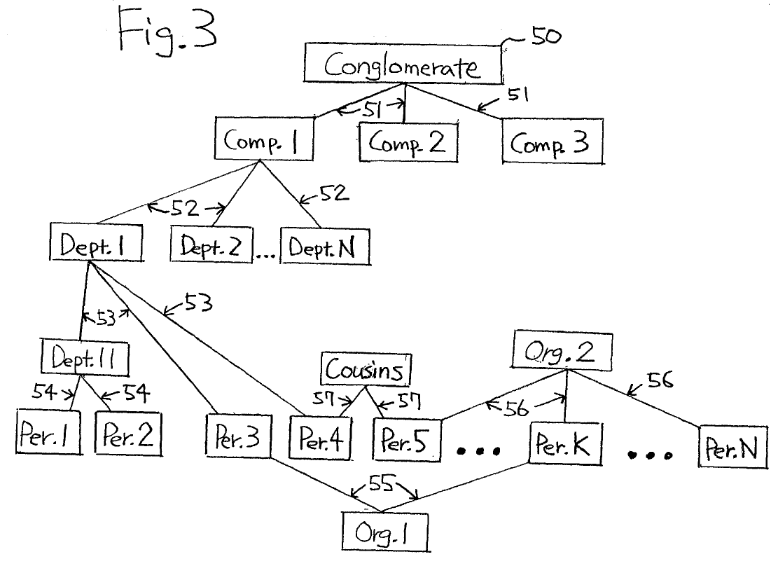

FIG. 3 depicts sample relations among various people and organizations, which are arranged in a tree structure in a social-relationship database suitable for use in a method of the present application. At the top of the tree structure, a Conglomerate 50 exists, which includes Companies 1 through 3 (Comp.1-Comp.3). The conglomerate and the companies are related to each other via conglomerate-company relationship 51. Company 1 includes a plurality of departments (Dept.1-Dept.N), and is related to these departments via company-department relationship 52. Department 1 in turn includes a Sub-department (Dept. 11), a Person (employee) 3 (Per.3), and a Person 4 (Per.4), via relationship 53. Dept. 11 further includes two people (Per.1 and Per.2), and is related to them via relationship 54.

Additionally, Person 3 is related to Person K via relationship 55 through Organization 1 (Org.1), perhaps outside his/her employment. Person K is also related to Person 5 and Person N via relationship 56 through Organization 2 (Org.2). Still further, Person 5 is related to Person 4 via relationship 57 because they are cousins.

A social-relationship database, in which the explicit relations among various people and organizations are arranged in a tree structure as shown in FIG. 3, can be created according to the logic of FIG. 4. The logic of FIG. 4 moves from a start block to a block 60 where relations among companies (e.g., the conglomerate-company relationship 51 in FIG. 3) are defined. In a block 61, for each company, its relationship with its internal departments is defined (e.g., the company-department relationship 52 in FIG. 3). In a block 62, for each department, its relationship with various sub-departments and/or employees within the department is defined (e.g., the relations 53 and 54 in FIG. 3). In a block 63, for each person (including any employee of a company), his or her personal relations outside of employment are defined (e.g., the relations 55, 56, and 57 in FIG. 3). In a block 64, any other relations between two or more entities (people and organizations) may be defined. The logic then moves to a decision block 65 where it is determined if all relations are explicitly defined (i.e., the social-relationship database is complete). If not, the logic moves back to any of 60, 61, 62, 63, and 64 to define those undefined relations. If all relations are defined, the logic of creating a social-relationship database ends.

As will be clear from the foregoing description, in particular FIG. 3, people and organizations are connected to one another through various relations in the social-relationship database. Also as will be clear, based on the “explicit” relationships 51-57 illustrated in FIG. 3, “implicit” relations can be extracted. For example, although Person 3 and Person 5 are not explicitly related to one another (i.e., there is no relationship line that directly connects the two entities), Person 3 is “implicitly” (indirectly) related to Person 5 because Person 3 is explicitly related to Person K via relationship 55 and Person K is explicitly related to Person 5 via relationship 56. In other words, Person 3 is implicitly related to Person 5 by traversing the explicit relationships 55 and 56. Alternatively or additionally, Person 3 is implicitly related to Person 5 because Person 3 is related to Person 4 via relationship 53 and Person 4 is related to Person 5 via relationship 57, i.e., by traversing the explicit relationships 53 and 57. As this example illustrates, there may be more than one implicit relationship between two entities. As a further example, Person 1 is implicitly related to Person 5 by traversing the explicit relationships 54, 53, and 57, and/or by traversing the explicit relationships 54, 53, 55, and 56. Therefore, based on some explicitly defined relations in the social-relationship database, numerous implicit relations can be established and extracted.

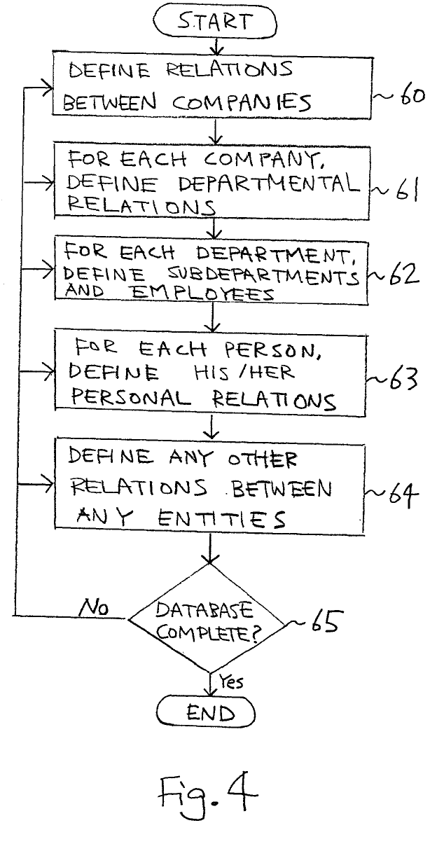

The implicit relations that can be extracted are based on the starting point of a search and how deep the search should proceed (search level). Specifically, FIGS. 5A-5D illustrate the search results that can be obtained from the data illustrated in FIG. 3, wherein the starting point of a search is either Person 1 or Person 2 and the search is conducted at increasingly greater search levels, respectively. FIG. 5A shows the explicit relationship 54 between (Per. 1) and (Per.2), who are both the members of Department 11. The search level is 1 in this case because only one explicit relationship (54) is used.

FIG. 5B shows one more explicit relationship, between (Per.3) and (Per.4) via the explicit relationship 53, and four implicit relations that can be extracted by starting from either Person 1 or Person 2 and traversing the two explicit relationships 54 and 53. Specifically, the implicit relations between (Per.1) and (Per.3); between (Per.2) and (Per.3); between (Per.1) and (Per.4); and between (Per.2) and (Per.4) can be obtained. The search level is 2 in this case because two explicit relationships (54 and 53) are traversed.

FIG. 5C shows two more explicit relationships: between (Per.3) and (Per.K) via the explicit relationship 55 (Org.1); and between (Per.4) and (Per.5) via the explicit relationship 57 (Cousins). Further, FIG. 5C shows four more implicit relations, each of which can be extracted by starting from either Person 1 or Person 2 and traversing three explicit relationships: between (Per. 1) and (Per.5) by traversing the relationships 54, 53, and 57; between (Per.1) and (Per.K) by traversing the relationships 54, 53, and 55; between (Per.2) and (Per.5) by traversing the relationships 54, 53, and 57; and between (Per.2) and (Per.K) by traversing the relationships 54, 53, and 55. The search level is 3 in this case because three explicit relationships, (54, 53, and 55) or (54, 53, and 57), are traversed in sequence to obtain these implicit relationships. (Also, a search at search level 3 may be carried out by traversing the explicit relationships 54, 53, and “52”, instead.)

FIG. 5D shows one additional explicit relationship, between (Per.5), (Per.K), and (Per.N) via the explicit relationship 56 (Organization 2), and eight additional implicit relations that can be extracted based on four explicit relationships, (54, 53, 55, and 56) or (54, 53, 57 and 56), originating from Person 1 or Person 2. These implicit relations include: between (Per.1) and (Per.5) by traversing the relationships 54, 53, 55, and 56; between (Per.2) and (Per.5) by traversing the relationships 54, 53, 55, and 56; between (Per. 1) and (Per.N) by traversing the relationships 54, 53, 55, and 56; between (Per.2) and (Per.N) by traversing the relationships 54, 53, 55, and 56; between (Per.1) and (Per.K) by traversing the relationships 54, 53, 57, and 56; between (Per. 1) and (Per.N) by traversing the relationships 54, 53, 57, and 56; between (Per.2) and (Per.K) by traversing the relationships 54, 53, 57, and 56; and between (Per.2) and (Per.N) by traversing the relationships 54, 53, 57 and 56. Note that in this example there are two implicit relationships established between (Per. 1) and (Per.N), and also two implicit relationships established between (Per.2) and (Per.N). (When a search at search level 3 was carried out based on the explicit relations 54, 53, and “52”, then the search at search level 4 would be based on the explicit relations 54, 53, 52, and “51”.)

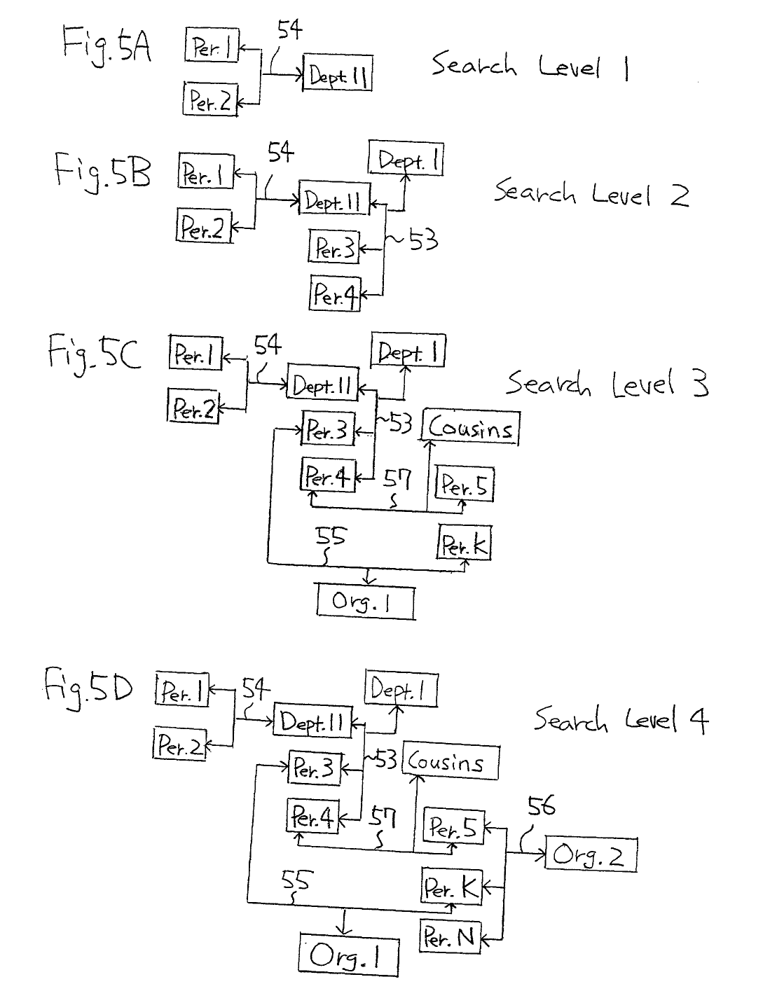

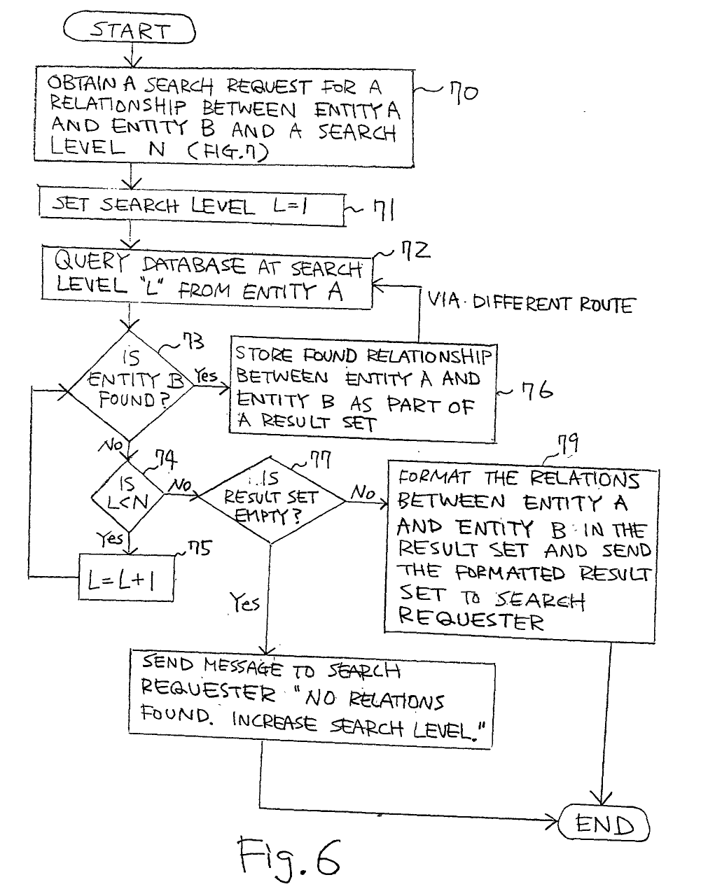

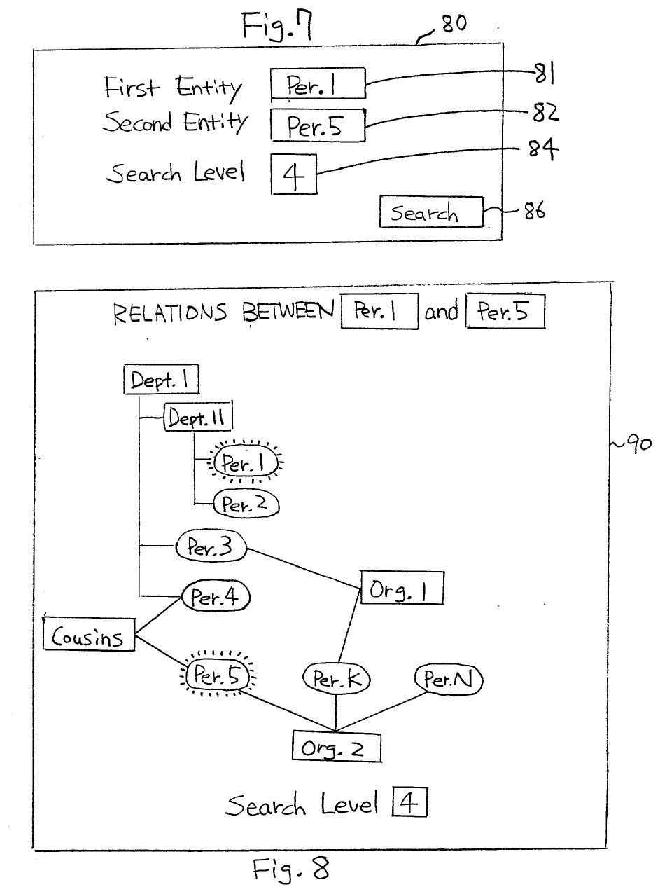

Thus the social-relationship database of the present invention allows not only the explicit relations defined therein but also the relations merely implicitly defined in the database to be extracted. As one particular embodiment, the database can be used to search and extract a relationship between two entities (persons or organizations), which may be either explicit or implicit, to determine if any relationship exists between the two. FIG. 6 is a flow diagram illustrating the logic of performing a search of this type in accordance with the present invention. The logic of FIG. 6 moves from a start block to a block 70 where a search request for a relationship between entity A (person or organization) and entity B (person or organization), together with a specific search level N, are received from the search requester (i.e., the client 22 in FIG. 1). FIG. 7 illustrates a sample data entry screen 80 for use by the search requester for this purpose. In the illustrated example, the search requester has entered in block 81 (Per.1) and in block 82 (Per.5), indicating that the requester wishes to know the relationship, if any, between these two people, which may be either explicit or implicit. The search requester has also requested in a block 84 that the search should be carried out at search level 4. After completing all blocks 81, 82, and 84, the search requester may click a search button 86 to send the search request to the server 20 (FIG. 1).

Referring back to FIG. 6, upon receiving a search request in block 70, the logic moves to a block 71, wherein search level counter “L” is set to 1. Next, in a block 72, the social-relationship database is queried at search level “L” (=1 at this point), traversing data starting from entity A. For example, continuing the illustrated example, the logic queries the database as shown in FIG. 3, starting from entity A (Per.1) at search level 1 to extract the relations shown in FIG. 5A. As discussed above, FIG. 5A shows the explicit relationship 54 between (Per. 1) and (Per.2). Referring back to FIG. 6, the logic then moves to a decision block 73, wherein it is determined whether entity B (Per.5 in the illustrated example) is found in the extracted relations. In the illustrated example, because (Per.5) is not found within the search results of FIG. 5A, the logic moves to another decision block 74, where it is determined whether the current search level “L” is lower than the search level “N” specified by the search requester. If so, the logic moves to a block 75, and the search level “L” is increased by 1. The logic then returns to the block 72, and queries the database at the increased search level (=2 at this point), again traversing data from entity A (Per. 1).

The logic repeats this routine until, at the decision block 73, it is determined that entity B (Per.5 in this example) is found. In the illustrated example, (Per.5) appears related to (Per. 1) for the first time at search level 3 (FIG. 5C). Specifically, FIG. 5C shows that (Per. 1) and (Per.5) are implicitly related to one another by traversing the explicit relationships 54, 53, and 57. Then, the logic moves to a block 76, wherein the obtained relationship between entity A and entity B is stored as part of a final result set. This, however, may not be the only relationship that exists between (Per. 1) and (Per. 5) at the current level (level 3). Thus, the logic returns to block 72, and repeats blocks 72, 73, and 76 as many times as there may be different relations (by traversing different sets of explicit relationships) between the two entities. If all the relationships between the two entities are found at the current level (level 3), at block 74, it is again determined whether the current search level “L” is lower than the requested search level “N”. Since in this example, the requested search level (4) is greater than the current search level (3), at block 75, the search level L is increased by 1 and the logic returns to the block 72 to query the database at the increased search level (=4). In block 73, the logic finds a level-4 relationship between (Per.1) and (Per.5) by traversing the explicit relationships 54, 53, 55, and 56. At block 76, this relationship is stored as one part of the result set, and the logic again repeats blocks 72, 73, and 76 as many times as there may be different relations between the two entities at level 4.

Still referring to FIG. 6, at block 74, it may be determined that the current search level “L” is not lower than the requested search level “N” specified by the search requester, i.e., the search has been conducted as far as requested by the search requester. Then, at a decision block 77, it is determined whether the result set is empty (i.e., no relationships have been found to exist between entity A and entity B). In such a case, moving to a block 78, the logic may send a message, such as “No Relations Found—Increase Search Level,” to the search requester, to inform the search requester that, although the requested relation was not found, it may be found if a further search (at a higher search level) is conducted. If in block 77, it is determined that the result set is not empty, then the logic moves to a block 79, wherein all the relationships found to exist between entity A and entity B are formatted and sent to the search requester. FIG. 8 illustrates a sample Web page 90 received by the search requester in response to the search request shown in FIG. 7. Viewing the screen of FIG. 8, the search requester can appreciate how (Per.1) and (Per.5) are related to each other via two relationships. First, they are related because (Per.1) and (Per.4) are the colleagues at (Dep.1) and (Per.4) and (Per.5) are cousins. Second, they are related because (Per.1) and (Per.3) are colleagues at (Dept.1), (Per.3) and (Per.K) are the members of (Org.1), and (Per.K) and (Per.5) are the members of (Org.2). As illustrated, (Per. 1) and (Per.5) may be highlighted so that the search requester can easily spot these entities and also their relationships.

While the preferred embodiments of the invention have been illustrated and described, it will be appreciated that various changes can be made therein without departing from the spirit and scope of the invention. For example, the present invention contemplates that once an explicit relationship is defined in the database, even when the relationship becomes outdated, the relationship is not removed from the database but merely designated as “inactive.” For example, when a person changes his employment, his previous employment record (i.e., an explicit relationship that existed with his previous employment) is not removed, but merely marked as “inactive”. This approach allows for the database to grow even if the relationships between people and organizations change.

The embodiments of the invention in which an exclusive property or privilege is claimed are defined as follows:

1. A method for performing a database search concerning social relations of a first entity, comprising:
(a) in response to a search request received from a search requester, the search request containing identification of a first entity, extracting explicit relations concerning the first entity; and
(b) extracting implicit relations concerning the first entity based on the extracted explicit relations.

2. The method of claim 1, wherein the explicit and implicit relations are extracted based on a search level received from the search requester.

3. The method of claim 1, further comprising:
(a) formatting the extracted explicit and implicit relations; and
(b) sending the formatted explicit and implicit relations to the search requester.

4. The method of claim 1, which is implemented over a network, wherein the explicit and implicit relations concerning the first entity are obtained from a social-relationship database coupled to the network.

5. The method of claim 4, wherein the network comprises the Internet.

6. The method of claim 1, wherein the search request further contains identification of a second entity, and explicit and implicit relations between the first and second identified entities are extracted.

7. A computer-readable medium having computer-executable instructions for performing the method of claim 1.

8. A computer-readable medium having computer-executable instructions for performing the method of claim 2.

9. A computer-readable medium having computer-executable instructions for performing the method of claim 3.

10. A computer-readable medium having computer-executable instructions for performing the method of claim 4.

11. A computer-readable medium having computer-executable instructions for performing the method of claim 5.

12. A computer-readable medium having computer-executable instructions for performing the method of claim 6.

13. An apparatus for performing a database search concerning social relations of a first entity, comprising:
(a) a processing unit; and
(b) a storage medium coupled to the processing unit, the storage medium storing program code implemented by the processing unit for performing the steps of:
(i) in response to a search request received from a search requester, the search request containing identification of a first entity, extracting explicit relations concerning the first entity; and
(ii) extracting implicit relations concerning the first entity based on the extracted explicit relations.

14. The apparatus of claim 13, wherein the program code implemented by the processing unit further performs the step of receiving a search level from the search requester, and in steps (b)(i) and (b)(ii) the explicit and implicit relations concerning the first entity are extracted based on the received search level.

15. The apparatus of claim 13, wherein the program code implemented by the processing unit further performs the steps of:
(a) formatting the extracted explicit and implicit relations; and
(b) sending the formatted explicit and implicit relations to the search requester.

16. The apparatus of claim 13, which is connected to a network, wherein the explicit and implicit relations concerning the first entity are obtained from a social-relationship database that is also connected to the network.

17. The apparatus of claim 16, wherein the network comprises the Internet.

18. The apparatus of claim 13, wherein the program code implemented by the processing unit further performs the step of receiving identification of a second entity from the search requester, and in steps (b)(i) and (b)(ii) the explicit and implicit relations between the first and second entities are extracted.
